(19) United States
(12) Patent Application Publication
(10) Pub. No.: US 2013/0131837 A1
(43) Pub. Date: May 23, 2013

(54) Prioritized Controller Arbitration

(71) Applicants: Rodney B. Washington, Raleigh, NC (US); Pierre Colle, Saint Martin d'Uriage (Isere) (FR)

(72) Inventors: Rodney B. Washington, Raleigh, NC (US); Pierre Colle, Saint Martin d'Uriage (Isere) (FR)

(73) Assignee: SCHNEIDER ELECTRIC USA, INC., Palatine, IL (US)

(21) Appl. No.: 13/418,815

(22) Filed: Mar. 13, 2012

(30) Foreign Application Priority Data
Nov. 22, 2011 (FR) 11 60630

(51) Int. Cl. G05B 11/01

(52) U.S. Cl. 700/12

(57) ABSTRACT

In a distributed control system where multiple controllers can control the same actuator or sensor, each controller is assigned a priority level, and command arbitration is based on the relative priority levels of the controllers. Each actuator or sensor selects a controller to serve as a master controller for one or more of its state variables. Different master controllers may be selected for different state variables. When a command is received by the actuator or sensor, it determines how to treat the command by comparing the priority of the controller from which the command originated to the priority of the master controller.

### BACKGROUND

The present invention relates generally to control systems for process control, and more particularly, to command arbitration in feedback control systems having multiple controllers.

A typical feedback control system comprises a single, centralized controller that receives feedback from one or more sensors and generates control signals for one or more actuators in the process. In this type of centralized control system, the control logic is implemented by a single controller with sufficient processing capability and memory to execute all of the data acquisition and control algorithms for the entire system.

A centralized control system can be easy to create and maintain because all of the control logic is at a single location. However, the processing requirements can be prohibitive if the central controller is expected to implement complex control algorithms, or to execute multiple control algorithms in parallel. Similarly, the bandwidth requirements to implement complex control algorithms may be prohibitive where data needs to be acquired from many remote sensors. Another drawback is that centralized control systems lack inherent robustness due to possible failure of the centralized controller. To ensure robustness, backup controllers may be required to ensure redundancy, which can make centralized control systems expensive to implement.

A hierarchical control system has multiple controllers distributed throughout the system to implement control functions. One or more controllers at each hierarchical level is designated as a master controller. The master controller can delegate control functions to subordinate controllers. The master controller is then responsible for coordinating the actions of the subordinate controllers to implement a process control algorithm.

Delegating responsibilities to the subordinate controllers reduces the processing requirements for the master controller. Having multiple subordinate controllers also reduces the complexity of executing multiple control algorithms in parallel. The subordinate controllers can be located in close proximity to the sensors or actuators under their control, thereby reducing the amount of data that the master controller needs to acquire and the bandwidth requirements of the master controller. The hierarchical control scheme ensures that only one controller is commanding each actuator, which avoids contention between controllers. Hierarchical control systems can be difficult to scale, since the addition of new controllers may require reprogramming of the master controller. Also, like centralized control systems, hierarchical control systems require redundant controllers to ensure robustness in the event that one of the controllers fails.

A distributed control system is a more complex control system where multiple controllers share responsibility for certain control functions. In a distributed control system, there is no single master controller for all control functions, and multiple controllers can exercise control over the same actuator and/or sensor. One example of this type of control system is a residential heating system with multiple heating elements and multiple controllers. The heating elements may be logically grouped into multiple zones. Each zone is independently controlled to maintain the temperature within the zone at a desired temperature set point. Each of the controllers is able to set the operating mode and desired temperature for each zone based on user input. In this example, the controllers need to work together in order to set a single mode and desired temperature for each zone without contention. Advantageously, distributed control systems can be scaled more easily than centralized or hierarchical control systems. Another advantage of distributed control systems is their inherent redundancy.

Command arbitration allows controllers in a distributed control system to work together to perform their intended control functions. A command arbitration procedure determines which controllers can control which actuators at a given time period. The actuator and corresponding sensor proving feedback can have many state variables requiring control. For example, in the residential heating system described above, each zone may have an operating mode (e.g., heating, cooling, and fan) and temperature set point. It is possible that different controllers may control different state variables for the same actuator at the same time.

One of the simplest methods of command arbitration for multiple controller systems is to allow the last command sent by any controller to determine the state of an actuator and its corresponding sensor. This technique is referred to as “last command arbitration.” With last command arbitration, an actuator or sensor owns its current state and each controller in the system must read the current state from the actuator or sensor before generating a new command. The controller must assume that its command will be overwritten by another controller without its knowledge.

Last command arbitration method requires coordination of the controller commands to be defined at an application level. For example, a controller should send a command only once and only when conditions require a change in the state. If the controllers were allowed to resend their last command, there would be command contention and ambiguous behavior. If a controller sends a command after another controller has read the current state, but before it has sent a new command, there may be a read-modified write error. The initial state will be lost to the controller and not used in the calculation of a new control command.

The last command arbitration method is generally suitable for control systems with only a few controllers that issue commands at a low rate using simple control logic that can adapt to changes in the state of the actuators and sensors by other controllers. A residential heating system is a good example where each controller issues commands based on the current state of the system, with no memory of previous commands.

Another method of command arbitration for a multiple controller system is referred to herein as “prioritized command arbitration.” This arbitration scheme assigns a priority level to each command. An actuator or sensor executes a received command only if the command has an equal or higher priority than the currently executing command. Contention between commands of equal priority may be resolved using the last command arbitration method based on the order in which the commands are received.

Prioritized command arbitration ensures that a lower priority arbitration command does not interfere with a higher priority command. Commands may be assigned a duration which allows the command to expire so that lower priority commands can be executed. In this case, a controller must resend a command in order to maintain control of the actuator or sensor. Prioritized command arbitration requires coordination of message priorities at the application level. Although the actuators and sensors perform arbitration during normal operations, the command priorities are set up by the application logic at the design time. The relative priorities of each command for each control are set up when the system is configured, and can be quite complex.

The prioritized command arbitration method applies best to systems with clearly definable critical messages. A command response energy management system that overrides user settings for the duration of a time is a good example.

Last command arbitration and prioritized command arbitration do not provide a mechanism to control the commands of another controller. In both last command arbitration and prioritized command arbitration, a controller may set simple limits on the ranges and timing of actuators and sensor variables. Thus, a controller may have some limited ability to block the command of another controller, but cannot directly control what commands are issued by the other controllers. This limitation may not meet the needs of a complex system with highly interrelated control logic and system states.

### SUMMARY

The present invention provides methods and apparatus for command arbitration in a distributed control system where a controlled device, such as actuator or sensor, is controlled by multiple controllers. Each controller is assigned a priority and command arbitration is based on the relative priority levels of the controllers. Each actuator or sensor selects a controller to serve as a master controller for one or more of its state variables. Different master controllers may be selected for different state variables. When a command is received by the actuator or sensor, it determines how to treat the command based on the priority of the controller from which the command originated. If the priority level of the originating controller is less than the priority level of the current master controller, the actuator or sensor forwards the command to the master controller. The master controller may chose to reissue the command with or without modifications, or to ignore the command. If the priority level of the originating controller is equal to the priority level of the current master controller, the actuator or sensor executes the command using last command arbitration to resolve contention. If the priority level of the originating controller is higher than the current master controller, the actuator or sensor executes the command and makes the originating controller the new master controller.

### BRIEF DESCRIPTION OF THE DRAWINGS

FIG. 1 illustrates a cooperative distributed control system with multiple controllers to control the functions of one or more actuators and sensors.

FIG. 2 is an exemplary command sequence illustrating prioritized controller arbitration.

FIG. 3 is an exemplary command sequence illustrating master controller selection for prioritized command arbitration.

FIG. 4 illustrates an exemplary prioritized controller arbitration method for a control system where multiple controllers exercise control in a coordinated manner over the same actuator or sensor.

FIG. 5 illustrates an exemplary actuator configured to implement the prioritized controller arbitration method.

FIG. 6 illustrates the main functional elements of a sensor configured to implement the prioritized controller arbitration method.

### DETAILED DESCRIPTION

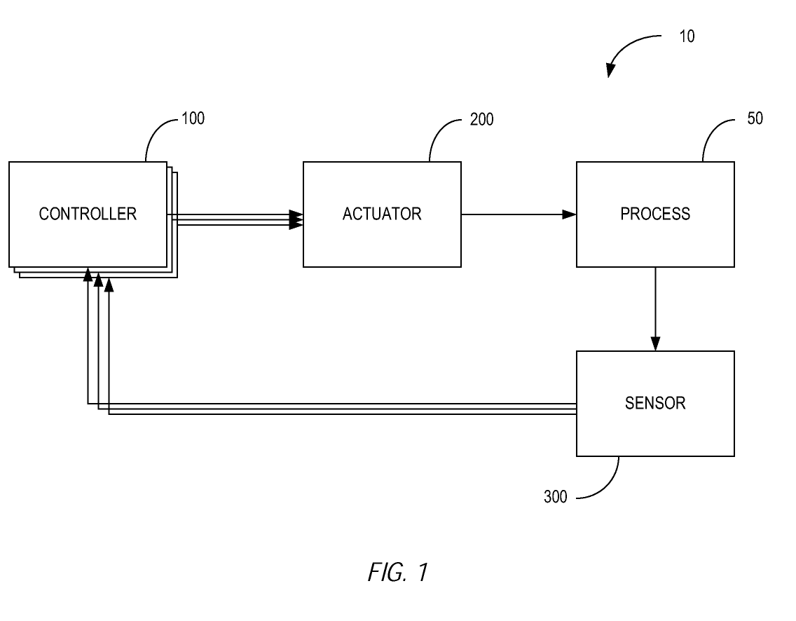

Referring now to the drawings, FIG. 1 schematically illustrates a cooperative distributed control system indicated generally by the numeral 10. The cooperative distributed control system 10 includes a plurality of controllers 100, one or more actuators 200, and one or more sensors 300. For convenience, only one actuator 200 and one sensor 300 are shown in FIG. 1. The controllers 100 share responsibility for controlling a process 50. The one or more sensors 300 provide feedback to the controllers 100 regarding the current state of the process 50. In response to the feedback from the one or more sensors 300, the controllers 100 can generate and send control commands to the one or more actuators 200 to implement a control algorithm. Typically, the commands are used to set the value of a state variable of the actuators 200 and sensors 300. The commands typically include an identifier identifying the controller sending the command, a priority indicator indicating the priority of the controller, a state variable identifier indicating the state variable targeted by the command, and a value for the state variable.

As one example, the control system 10 may control a residential heating system with multiple heating elements. The heating elements may be logically grouped into multiple zones where each zone has its own operating mode (e.g. on/off) and desired temperature set point. Each of the controllers 100 is able to set the operating mode and desired temperature set point for each zone based on user input.

In the cooperative distributed control system 10 according to the present invention, each controller 100 acts independently but coordinates its actions with other controllers 100 to implement control functions of the system 10. Some controllers 100 may be capable of performing all control functions, while other controllers 100 may perform only a subset of the control functions. Thus, some of the control functions may be subject to control by more than one controller 100. Because more than one controller 100 may be responsible for some control functions, there will be command contention, and a command arbitration procedure is needed.

In the disclosed embodiments, a command arbitration scheme based on controller priority is implemented. In the prioritized controller arbitration scheme described herein, each controller 100 is assigned a priority. Controllers 100 with different priority levels may attempt to control an actuator 200 or sensor 300. Command arbitration is based on the relative priority levels of the controllers 100.

The term “control set” will be used herein to refer to the set of controllers 100 that actively control the same actuator 200 or sensor 100. The actuator 200 or sensor 300 being controlled designates a controller 100 in its control set with the highest priority as its master controller. If multiple controllers 100 have the same priority, the master controller will be the first to command the actuator 200 or sensor 300. Controllers 100 with a priority level lower than the master controller are referred to herein as subordinate controllers. Controllers 100 having the same priority as the master controller are referred to as peer controllers. The term “originating controller” will be used to refer to a controller that sends a command. Any controller 100 can be an originating controller.

The master controller does not have direct control over the subordinate controllers, but instead controls certain state variables of an actuator 200 or sensor 300. If an actuator 200 or sensor 300 receives a command from a subordinate controller, the command is forwarded to the current master controller without action by the actuator 200 or sensor 300. The master controller may reissue the command with or without modifications, or may ignore the command. A command from a peer controller is executed using last command arbitration to resolve contention.

The actuators 200 and sensors 300 are designed to dynamically select a new master controller responsive to changes in system topology. If the current master controller for an actuator 200 or sensor 300 is removed or becomes non-responsive, the actuator 200 or sensor 300 will select a new master controller from its control set. After the removal of the current master controller, the actuator 200 or sensor 300 will continue to receive control commands from the remaining controllers 100. When the actuator 200 or sensor 300 receives a command after the master controller is removed or becomes non-responsive, the actuator 200 or sensor 300 can designate the originating controller as the new master controller. If the actuator 200 or sensor 300 later receives a control command from a controller 100 in its control set with a higher priority, the originating controller with the higher priority will be designated as the new master controller and the old master controller becomes a subordinate controller. Eventually, the controller 100 in the control set with the highest priority will be selected as the master controller.

Reselection of a master controller may also occur when a new controller 100 with high priority is added to the control system 10. The new controller 100 will appear to the actuators 200 and sensors 300 when it sends commands. When an actuator 200 or sensor 300 receives a command from a new controller 100 with a priority higher than the current master controller, the new controller 100 is designated as the new master controller and the old master controller becomes a subordinate controller.

In one exemplary embodiment, the controller priority levels may be assigned based on the “intelligence” of the controllers 100. The controller intelligence is determined based on the controller's processing capabilities and the complexity of the control algorithms that it can support. Controller priority levels are not dependent on the system topology of the particular control system, but instead are predefined by an application architect. For example, a manufacturer of the control system components may offer a line of controllers 100 with different priority levels. A system installer or user can select and combine the controllers 100 in any manner. The control system 10 will self-organize so that the controllers 100 with the highest priority levels will have effective control over the control functions. Low level run-time command arbitration may still be performed by an actuator 200 or sensor 300 using last command arbitration.

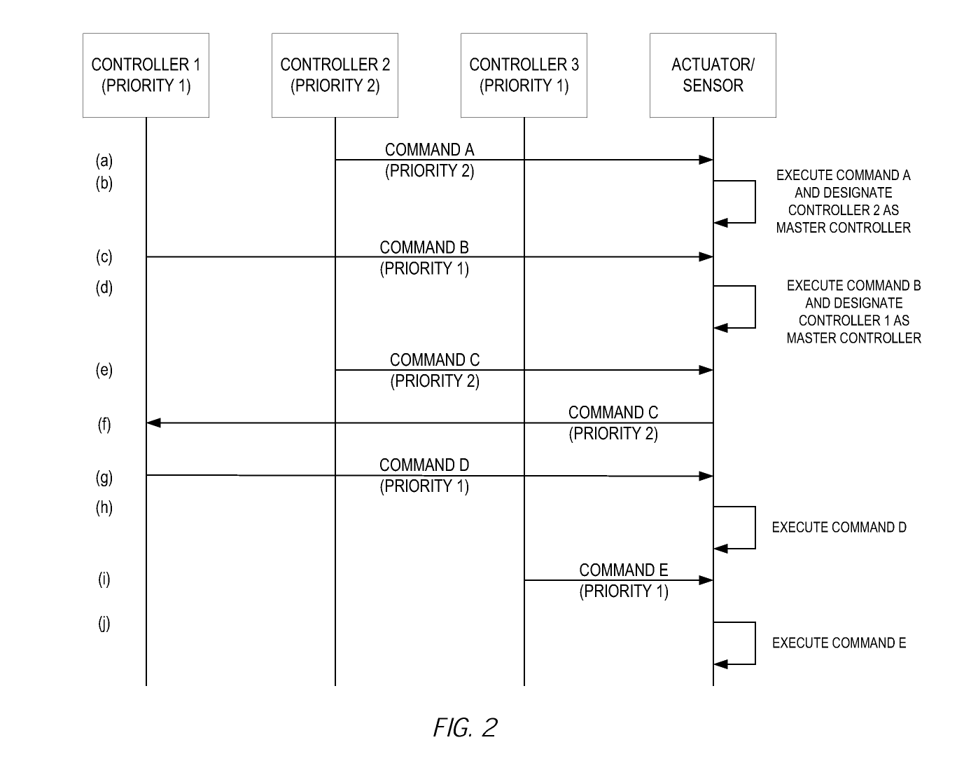

FIG. 2 illustrates an exemplary arbitration sequence in a control system 10 implementing the prioritized controller arbitration scheme described above. In this example, there are 3 controllers denominated as Controller 1, Controller 2 and Controller 3. Controllers 1 and 3 have a priority level of 1, while Controller 2 has a priority level of 2. In this example, the priority level of 1 is the highest priority level. Initially, Controller 2 (priority level 2) sends a command to an actuator 200 or sensor 300 (step a). Because Controller 2 is the first controller 100 to issue a command to the actuator 200 or sensor 300, the actuator 200 of sensor 300 designates Controller 2 as the master controller and executes the command (step b). Controller 1 (priority level 1) subsequently sends another command to the actuator 200 or sensor 300 (step c). Because it has a higher priority level than Controller 2, the actuator 200 or sensor 300 designates Controller 1 as the new master controller and the command is immediately executed (step d). Later, when Controller 2 sends a command to the actuator 200 or sensor 300 (step e), the command is forwarded to Controller 1, the master controller, without execution (step f). In some embodiments, Controller 1 may send an acknowledgement of the command to the actuator or sensor 100 to confirm its receipt of the command. Controller 1 can re-issue the command with or without modification, or ignore the command. In the example shown in FIG. 2, Controller 1 modifies the command and then sends the modified command to the actuator 200 or sensor 300 (step g). The modified command is then executed by the actuator 200 or sensor 300 (step h). Later, Controller 3 sends a command to the sensor 300 (step i). Controller 3 has the same level of priority as Controller 1, which is serving as the current master controller. In this case, the actuator 200 or sensor 300 immediately executes the command from Controller 3 using last command arbitration to resolve contention (step j). Controller 1 remains the master controller.

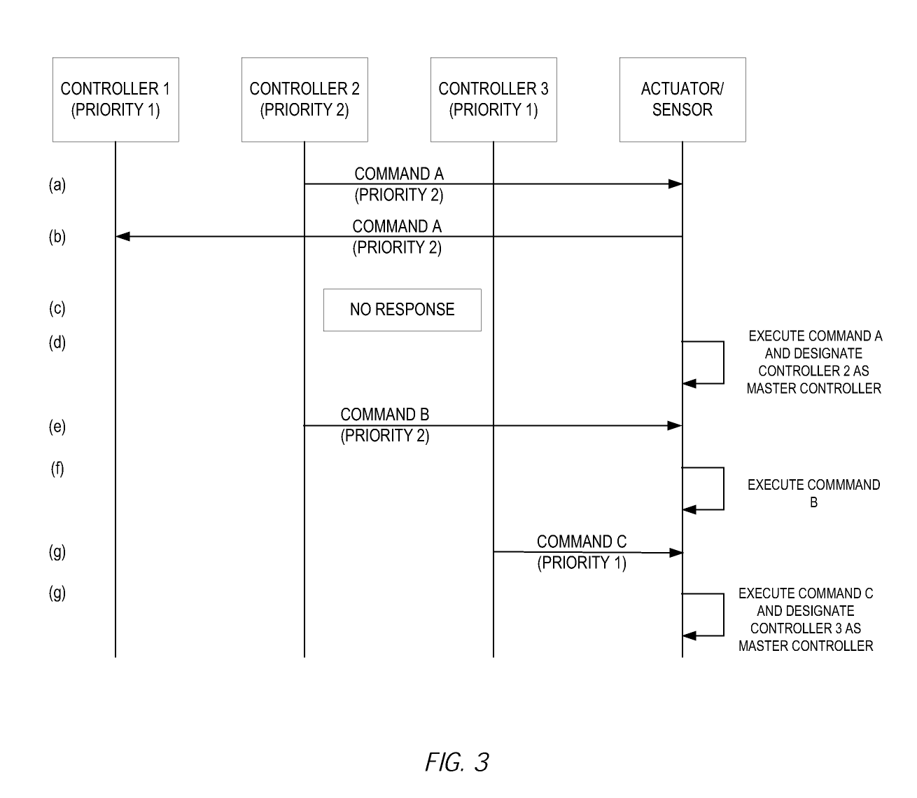

FIG. 3 illustrates an exemplary sequence showing reselection of a master controller. The sequence starts with Controller 1 as the current master controller. Controller 2, with a priority level lower than Controller 1, sends a command to the actuator 200 or sensor 300 (step a). Because Controller 2 has a priority level lower than Controller 1, the actuator 200 or sensor 300 forwards the command to Controller 1 (step b). In this example, Controller 1 fails to acknowledge the command or otherwise respond. The failure to respond may indicate that Controller 1 has been removed, or is not functioning. When Controller 1 fails to respond to the actuator 200 or sensor 300 within a predefined period of time (step c), the actuator 200 or sensor 300 designates Controller 2 as the new master controller (step d) and executes the command. When Controller 2 sends a new command (step e), the actuator 200 or sensor 300 immediately executes the command (step f). Later, Controller 3 sends a command to the actuator 200 or sensor 300 (step g). Because Controller 3 has a higher priority level than Controller 2, the actuator 200 or sensor 300 designates Controller 3 as the new master controller and immediately executes the command.

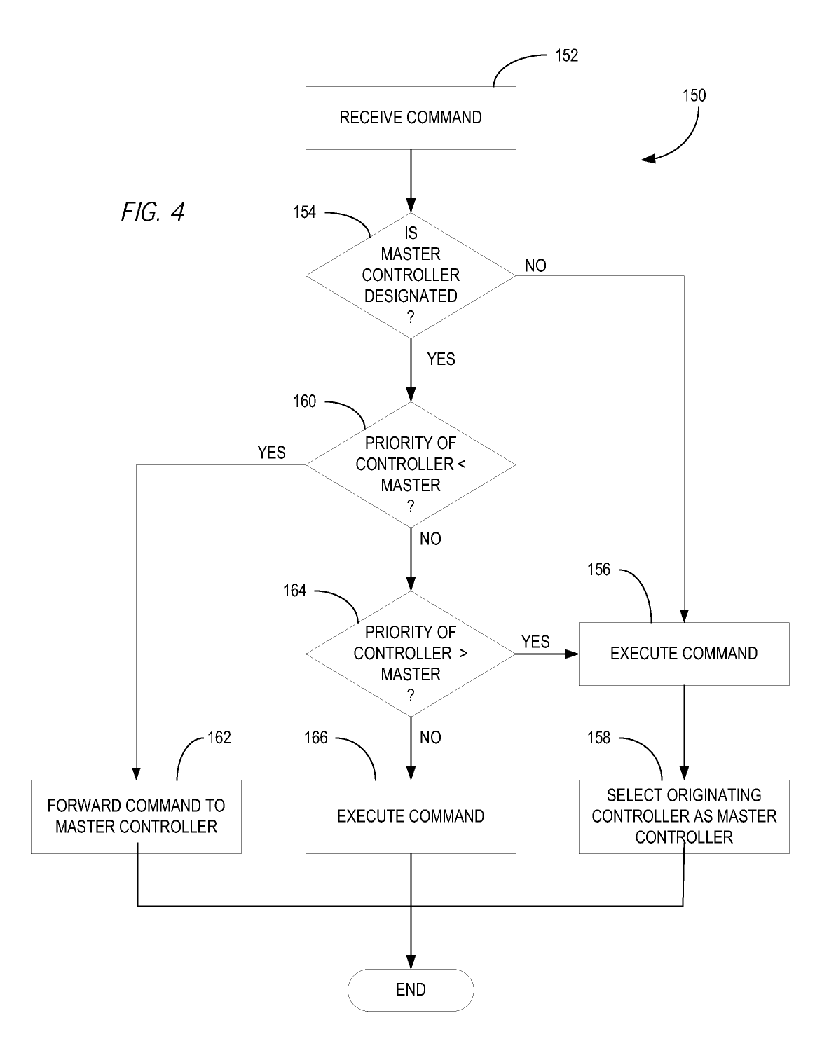

FIG. 4 illustrates an exemplary command arbitration procedure 150 for the control system 10 where multiple controllers exercise control in a coordinated manner over the same actuator 200 or sensor 300. The command arbitration procedure 150 is performed by an actuator 200 or sensor 300 that is being controlled by multiple controllers 100. The procedure 150 begins when the actuator 200 or sensor 300 receives a command from a controller 100 within its control set (block 152). The actuator or sensor 300 initially determines whether a master controller has been designated for the state variable that is the object of the command (block 154). As previously noted, different master controllers can be designated for different state variables of the same actuator 200 or sensor 300. If no master controller has been designated, the actuator 200 or sensor 300 executes the command (block 156) and designates the controller 100 from which the command originated (i.e. the “originating controller”) as the master controller (block 158). If a master controller has been designated, the actuator 200 or sensor 300 compares the priority level of the originating controller to the priority level of the master controller (block 160, 164). If the priority level of the originating controller is less than the master controller (block 160), the actuator 200 or sensor 300 forwards the command to the master controller (block 162). In the case where the priority level of the originating controller is greater than the master controller (block 164), the actuator 200 or sensor 300 executes the command (block 156) and designates the originating controller as the master controller (block 158). If the priority level of the originating controller is the same as the master controller, the actuator 200 or sensor 300 executes the command (block 166).

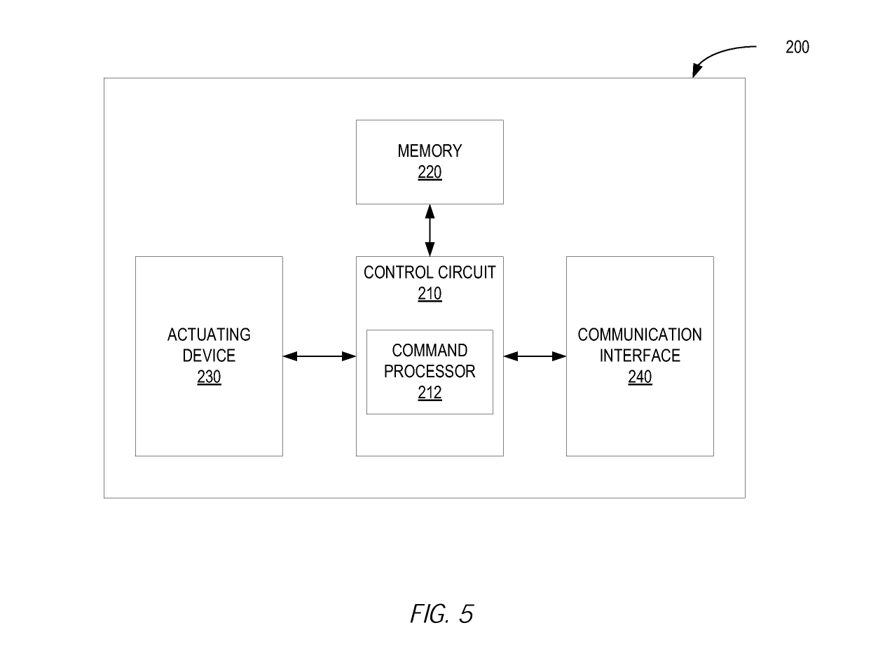

FIG. 5 illustrates the main functional elements of an actuator 200. The actuator 200 comprises a control circuit 210, memory 220, an actuating device 230, and a communication interface 240. The control circuit 210 controls the operation of the actuator 200 as previously described. The control circuit 210 may be implemented by one or more processors, hardware circuits, firmware, or a combination thereof. The control circuit 210 includes a command processor 212 to process commands received from the controllers 100. The command processor 212 is configured to receive commands from the controllers 100 via the communication interface 240, select one of the controllers 100 as the master controller for each of its state variables, forward the commands from subordinate controllers to the master controller via the communication interface 240, and execute commands from its peer controller or master controller.

Memory 220 stores program instructions and data needed by the control circuit 210 to perform its functions. Memory 220 also stores the current values of its state variables. Memory 220 may, for example, comprise a non-volatile memory device such an electrically erasable programmable read only memory (EEPROM), flash memory, or magnetoresistive random access memory (MRAM). A volatile memory device, such a random access memory (RAM), may also be used to store temporary data.

The actuating device 230 comprises a control device that is used to control a process. As one example, the actuating device 230 may comprise an on/off switch to control the power to a component in a process. In a residential heating system, an on/off switch can be used to control the supply of power to heating elements, fans, or other devices in the process, for example. In this case, the state of the switch may comprise one of the state variables that is controlled by the controllers 100.

The communication interface 240 provides a connection to a local area network (LAN) and enables the actuator 200 to communicate with the controllers 100 in the control system 10. If the LAN comprises a wireline network, the communication interface may comprise an Ethernet interface. Alternatively, the communication interface 240 may comprise a WiFi interface, BLUETOOTH interface, ZIGBEE interface, or other wireless radio interface to connect to a wireless access point (WAP) in the LAN.

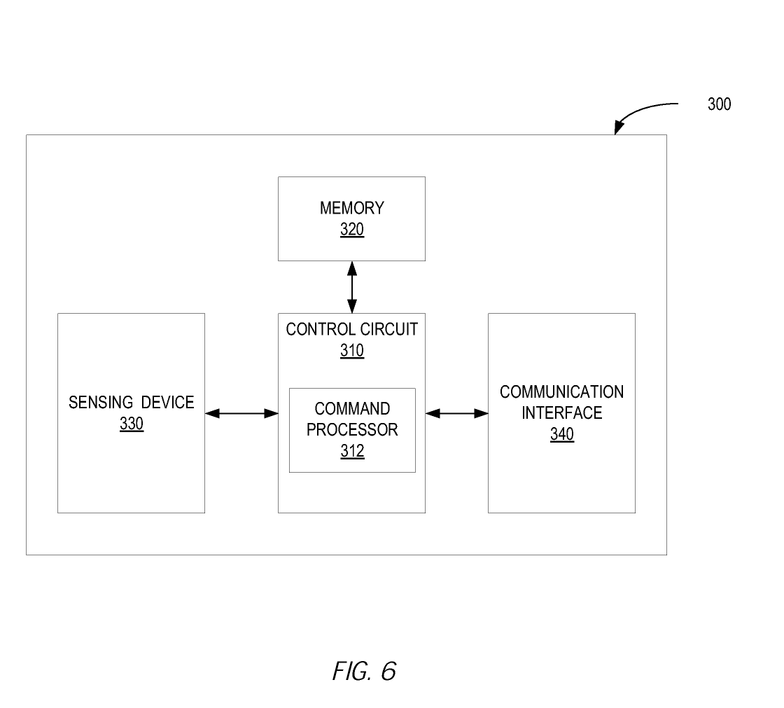

FIG. 6 illustrates the main functional elements of a sensor 300. The sensor 300 comprises a control circuit 310, memory 320, sensing device 330, and communication interface 340. The control circuit 310 controls the operation of the sensor 300 as previously described. The control circuit 310 may be implemented by one or more processors, hardware circuits, firmware, or a combination thereof. The control circuit 310 includes a command processor 312 to process commands received from the controllers 100. The command processor 312 is configured to receive commands from the controllers 100 via the communication interface 340, select one of the controllers 100 as the master controller for each of its state variables, forward commands from subordinate controllers to the master controller via the communication interface 340, and execute commands from the master controller or peer controllers.

Memory 320 stores program instructions and data needed by the control circuit 310 to perform its functions. Memory 320 also stores the current values of its state variables. Memory 320 may, for example, comprise a non-volatile memory device such as electrically erasable programmable read only memory (EEPROM), flash memory, or magnetoresistive random access memory (MRAM). A volatile memory device, such a random access memory may also be used to store temporary data.

The sensing device 330 comprises any type of transducer that senses a parameter of the controlled process and generates an electrical signal indicative of the current value of the parameter. As one example, the sensing device 330 may comprise a temperature transducer to measure the temperature. In a residential heating system, a temperature transducer can be used to measure the temperature in a room and report the temperature to the controllers 100.

The communication interface 340 provides a connection to a local area network (LAN) and enables the sensor 300 to communicate with the controllers 100 in the control system 10. If the LAN comprises a wireline network, the communication interface 340 may comprise an Ethernet interface. Alternatively, the communication interface 340 may comprise a WiFi interface, BLUETOOTH interface, ZIGBEE interface, or other wireless radio interface to connect to a wireless access point (WAP) in the LAN.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of performing command arbitration in a distributed control system having multiple controllers, said method comprising:
selecting a controller in a control set comprising multiple controllers as a master controller for one or more state variables;
receiving, from an originating controller other than the current master controller, a command to set a targeted one of the state variables;
comparing a priority level of the originating controller to a priority level of the current master controller for the targeted state variable;
forwarding the command to the master controller if the priority level of the originating controller is less than the priority level of the current master controller; and
setting the state variable responsive to the command if the priority level of the originating controller is greater than the priority level of the current master controller.

2. The method of claim 1 further comprising designating the originating controller as a new master controller to replace the current master controller for the targeted state variable if the priority level of the originating controller is greater than the priority level of the current master controller.

3. The method of claim 1 further comprising setting the targeted state variable responsive to the command if the priority level of the originating controller is equal to the priority level of the current master controller.

4. The method of claim 1 further comprising selecting a new master controller when the current master controller is no longer detected.

5. The method of claim 1 wherein selecting a controller in a control set comprising multiple controllers as a master controller comprises:
selecting a first master controller for a first group of state variables; and
selecting a second master variable for a second group of state variables.

6. An actuator or sensor in a distributed control system, said actuator or sensor comprising:
a communications interface for communicating over a network with a plurality of distributed controllers; and
a control circuit for arbitrating contention between commands received from different controllers, said control circuit including a command processor configured to:
select a controller in a control set comprising multiple controllers as a master controller for one or more state variables;
receive, from an originating controller other than the master controller, a command to set a targeted one of the state variables;
compare a priority level of the originating controller to a priority level of the master controller for the targeted state variable;
forward the command to the master controller if the priority level of the originating controller is less than the priority level of the master controller; and
set the state variable responsive to the command if the priority level of the originating controller is greater than the priority level of the master controller.

7. The actuator or sensor of claim 6 wherein the command processor is configured to designate the originating controller as a new master controller to replace the current master controller for the targeted state variable if the priority level of the originating controller is greater than the priority level of the master controller.

8. A method implemented by an actuator or sensor in a cooperative control system of selecting a master controller, said method comprising:
receiving, from a first controller, a command targeted to a first state variable of the actuator or sensor;
determining whether a master controller is currently designated for the first state variable;
if no master controller is currently designated for the first state variable, designating the first controller as the master controller for the first state variable.

9. The method of claim 8 further comprising:
if a master controller is currently designated for the first state variable, comparing a priority level of the first controller to a priority level of the current master controller for the first state variable; and
designating the first controller as a new master controller for the first state variable to replace the current master controller if the priority level of the first controller is greater than the priority level of the current master controller.

10. The method of claim 9 further comprising forwarding the command to the current master controller if the priority level of the first controller is lower than the priority level of the current master controller for the first state variable.

11. The method of claim 8 further comprising:
receiving, from a second controller, a command targeted to a second state variable of the actuator or sensor;
comparing a priority level of the originating controller to a priority level of a current master controller for the second state variable;
designating the second controller as a new master controller for the second state variable to replace the current master controller if the priority level of the second controller is greater than the priority level of the current master controller.

12. The method of claim 11 further comprising:
if a master controller is designated for the second state variable, comparing a priority level of the second controller to a priority level of a current master controller for the second state variable; and
designating the second controller as a new master controller for the second state variable to replace the current master controller if the priority level of the second controller is greater than the priority level of the current master controller.

13. An actuator or sensor in a distributed control system, said actuator or sensor comprising:
a communications interface for communicating over a network with a plurality of distributed controllers; and
a control circuit for selecting a master controller for one or more state variables of the actuator or sensor, said control circuit including a command processor configured to:
receive, from a first controller, a command targeted to a first state variable of the actuator or sensor;
determine whether a master controller is designated for the first state variable;
if no master controller is designated for the first state variable, designate the first controller as the master controller for the first state variable.

14. The actuator or sensor of claim 13 wherein the command processor is further configured to:
compare a priority level of the first controller to a priority level of a current master controller for the first state variable if a master controller is designated for the first state variable; and
designate the first controller as a new master controller for the first state variable to replace the current master controller if the priority level of the first controller is greater than the priority level of the current master controller.
